(19) United States
(12) Patent Application Publication
(10) Pub. No.: US 2021/0392855 A1
(43) Pub. Date: Dec. 23, 2021

(54) LEASH CUFF

(71) Applicant: OCEAN RODEO SPORTS INC., Victoria (CA)

(72) Inventor: Reece MYERSCOUGH, Tofino (CA)

(21) Appl. No.: 17/341,557

(22) Filed: Jun. 8, 2021

Related U.S. Application Data
(60) Provisional application No. 63/040,390, filed on Jun. 17, 2020.

(51) Int. Cl. A01K 27/00

(52) U.S. Cl. CPC A01K 27/005; A01K 27/001

(57) ABSTRACT

A leash cuff includes a cuff body and a leash attachment fitting. A suspension assembly connects the leash attachment fitting to the cuff body. The suspension assembly is movable between an extended position and a retracted position in response to forces exerted upon the leash attachment fitting. The suspension assembly prevents forces exerted upon the leash attachment fitting from deforming the cuff body, which can cause discomfort to the user or lead to the user becoming entangled with the leash.

### FIELD

There is described a leash cuff which is used to attach a leash to a body of a user.

### BACKGROUND

When doing many water based board sports, a user often uses a leash to attach himself or herself to their board. A leash cuff is attached to the user's ankle or wrist, and the leash runs between the leash cuff and the board. The leash prevents the board from floating away from the user when he or she falls.

The leash cuff is attached and tightened, such that the leash cuff doesn't rotate around the user's ankle or wrist. If the leash cuff were able to rotate, it would result in the leash twisting and potentially entangling the user. Entanglement may lead to a dangerous situation for the user, particularly in water sports where there is a danger of drowning.

### SUMMARY

There is provided a leash cuff that includes a cuff body having a first end, a second end and a fastener that secures the first end to the second end. A leash attachment fitting is provided along with a suspension assembly for connecting the leash attachment fitting to the cuff body. The suspension assembly is movable between an extended position and a retracted position in response to forces exerted upon the leash attachment fitting.

It will be understood that when a water sports board pulls on the leash; the leash, pulls on the leash cuff. The current state of the art leash cuffs do not use any methods to dissipate a load created by this pull. When the leash cuff is pulled, the shape of the leash body changes. If the leash cuff becomes able to rotate, this can result in the leash twisting and potentially entangling the user. This may also result in discomfort for the user, if the leash cuff is pulled into a shape which constricts the user's wrist or ankle, or if the leash attachment fitting twists into the user's wrist or ankle.

The above described leash cuff, avoids these problems by providing a suspension assembly between the cuff body and the leash attachment fitting. The suspension assembly dissipates the load, without affecting the shape of the cuff body. This means that the leash cuff still retains its ability to not rotate about the user's ankle or wrist reducing the chances of the user from becoming entangled in the leash line.

It will be understood that, although described throughout in the context of water based board sports, the described leash cuff has broader application and can be used to tether a user to a kite or any other attached object.

Although the leash cuff was originally intended to be attached to a user's wrist, or ankle, it is not limited to such, and can be attached to any part of a user, such as but not limited to their waist, calf or thigh.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a leash cuff.

FIG. 2 is a perspective view of the leash cuff illustrated in FIG. 1, with a perpendicular pulling force on a leash attached to the leash cuff.

FIG. 3 is a perspective view of the leash cuff illustrated in FIG. 1 with an angled pulling force on a leash line attached to the leash cuff.

FIG. 4 is a top view of the leash cuff illustrated in FIG. 1.

FIG. 5 is a top view of the leash cuff illustrated in FIG. 2, with the perpendicular pulling force on the leash.

FIG. 6 is a top view of the leash cuff illustrated in FIG. 3 with the angled pulling force on the leash.

FIG. 7 is a perspective view of the leash cuff illustrated in FIG. 1, with an added quick release for the leash.

### DETAILED DESCRIPTION

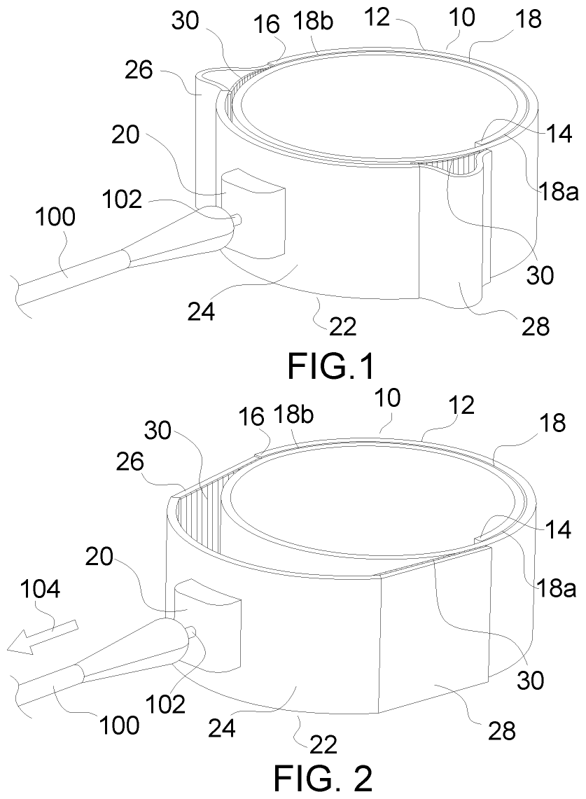

A leash cuff generally identified by reference numeral 10, will now be described with reference to FIG. 1 through FIG. 7.

### Structure and Relationship of Parts:

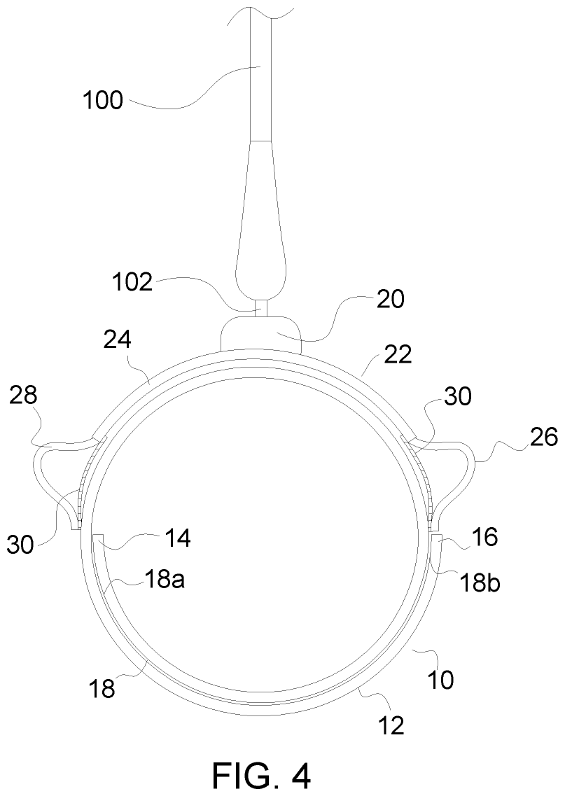

Referring to FIG. 1 and FIG. 4, leash cuff 10 includes a cuff body 12 having a first end 14, a second end 16 and a fastener 18 that secures first end 14 to second end 16. It will be appreciated that there are a variety of types of fasteners that could be used. Fastener 18 chosen for illustration is a mating tape fastener 18. Mating tape fastener 18 is viewed as being the best form of fastener to use. Mating tape fastener 18 has a first component 18a on first end 14 and a second component 18b on second end 16 and serves to secure first end 14 and second end 16 together in overlapping relation.

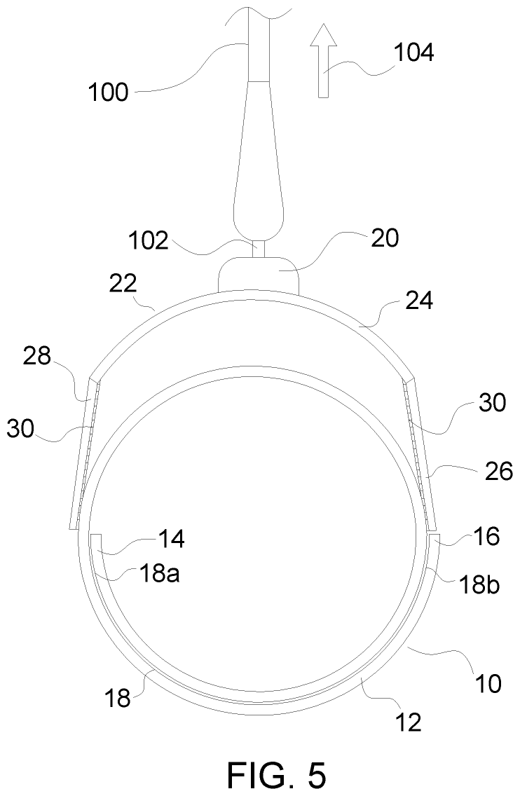

Referring to FIG. 1 and FIG. 4, a leash attachment fitting 20 is connected by a suspension assembly 22 to cuff body 12. It will be appreciated that suspension assembly can take a number of forms. Suspension assembly 22, as chosen for illustration, includes a band of material 24 having opposed ends 26 and 28. Opposed ends 26 and 28 are secured in spaced relation to cuff body 12. Suspension assembly 22 is movable between an extended position as illustrated in FIG. 2 and FIG. 5 and a retracted position as illustrated in FIG. 1 and FIG. 4. As will hereinafter be further described in relation to operation, suspension assembly 22 moves between the extended position and the retracted position in response to forces exerted upon leash attachment fitting 20. An elastic element 30 serves to dampen movement between the extended position and the retracted position and biases suspension assembly 22 into the retracted position illustrated in FIG. 1 and FIG. 4.

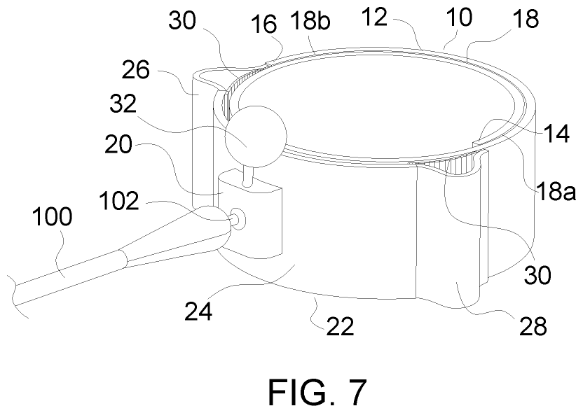

Referring to FIG. 7, for reasons of safety, it is preferred that leash attachment fitting 20 include a quick release 32, such that by manually triggering quick release 32 a leash 100 is rapidly released from leash attachment fitting 20.

### Operation:

Referring to FIG. 1 and FIG. 4, in preparation for use one end 102 of leash 100 is attached to leash attachment fitting 20. The opposite end of leash 100, which has not been illustrated, would be attached to a water sports board or other object. Cuff body 12 is placed around a wrist or ankle of a user and secured in place by mating tape fastener 18 by mating first component 18a on first end 14 with second component 18b on second end 16 to secure first end 14 and second end 16 together in overlapping relation. In FIG. 1 and FIG. 4, leash cuff 10 is illustrated as it would appear before any force is exerted.

Referring to FIG. 2 and FIG. 5, a perpendicular pulling force on leash 100, as indicated by arrow 104, is transferred by leash 100 to leash attachment fitting 20. This causes suspension assembly 22 to move from the retracted position of FIG. 1 and FIG. 4 to the extended position of FIG. 2 and FIG. 5. Elastic element 30 helps absorb and dampen this movement. Elastic element 30 also causes suspension assembly 22 to return to the retracted position illustrated in FIG. 1 and FIG. 4 when the force ends. The important thing to note is that cuff body 12 is sheltered from the force, so the previously noted causes of failure or discomfort for the user are avoided.

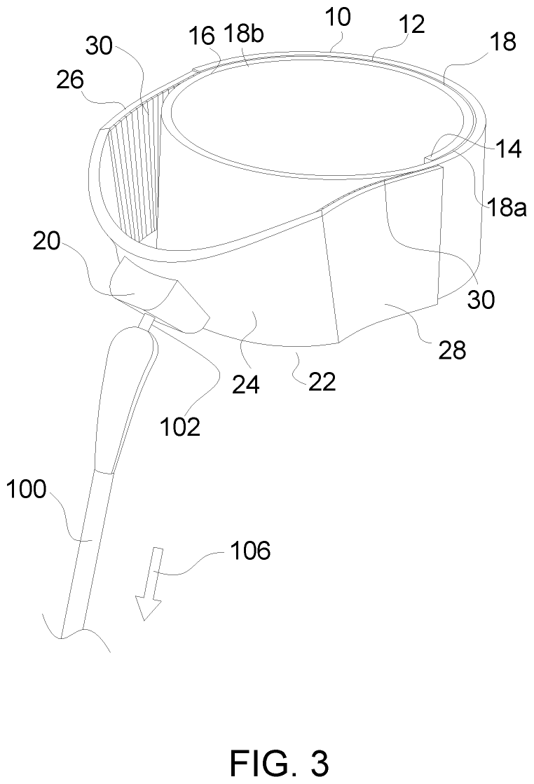

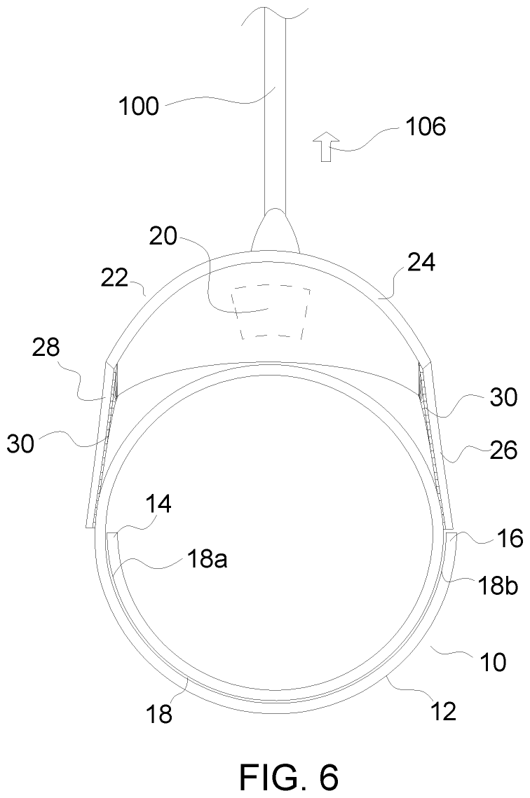

It will be appreciated that not all pulling forces will be perpendicular pulling forces 104, as illustrated in FIG. 2 and FIG. 5. Referring to FIG. 3 and FIG. 6, there is shown the reaction of suspension assembly 22 to an angled pulling force, as indicated by arrow 106. In such a case, not only does suspension assembly 22 expand to the expanded position, it also accommodates a rotation of the leash attachment fitting 20 in the direction of angled pulling force 106.

The purpose of leash 100 is to ensure that the user does not lose his or her board or other object. However, there are times when the user is in such peril that the loss of the board is a secondary consideration and the user is prepared to risk the loss of the board to save himself or herself from injury or death. Referring to FIG. 7, in such cases, quick release 32 is manually activated to release end 102 of leash 100 from leash attachment fitting 20.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A leash cuff comprising:
a cuff body having a first end, a second end and a fastener that secures the first end to the second end;
a leash attachment fitting; and
a suspension assembly connecting the leash attachment fitting to the cuff body, the suspension assembly being movable between an extended position and a retracted position in response to forces exerted upon the leash attachment fitting.

2. The leash cuff of claim 1, wherein the suspension assembly is comprised of a band of material having opposed ends, each of the opposed ends being secured to the cuff body.

3. The leash cuff of claim 1, wherein the suspension assembly includes an element to dampen movement between the extended position and the retracted position.

4. The leash cuff of claim 3, wherein the element to dampen movement is an elastic element.

5. The leash cuff of claim 4, wherein the suspension assembly is biased into the retracted position by the elastic element.

6. The leash cuff of claim 1, wherein the fastener used to secure the first end of the cuff body to the second end of the cuff body is a mating tape fastener having a first component on the first end and a second component on the second end in order to secure the first end and the second end in overlapping relation.

7. The leash cuff of claim 1, wherein the leash attachment fitting includes a quick release, such that by manually triggering the quick release a leash is rapidly released from the leash attachment fitting.

8. A leash cuff comprising:
a cuff body having a first end, a second end and a fastener that secures the first end to the second end;
a leash attachment fitting; and
a suspension assembly connecting the leash attachment fitting to the cuff body, the suspension assembly is comprised of a band of material having opposed ends, each of the opposed ends being secured to the cuff body, the suspension assembly being movable between an extended position and a retracted position in response to forces exerted upon the leash attachment fitting, an elastic element dampening movement between the extended position and the retracted position and biasing the suspension assembly into the retracted position.

9. The leash cuff of claim 8, wherein the fastener used to secure the first end of the cuff body to the second end of the cuff body is a mating tape fastener having a first component on the first end and a second component on the second end in order to secure the first end and the second end in overlapping relation.

10. The leash cuff of claim 8, wherein the leash attachment fitting includes a quick release, such that by manually triggering the quick release a leash is rapidly released from the leash attachment fitting.
